(19) United States
(12) Patent Application Publication
(10) Pub. No.: US 2011/0059644 A1
(43) Pub. Date: Mar. 10, 2011

(54) CABLE ASSEMBLY WITH FLAT CABLE

(75) Inventors: CHIN-PAO KUO, Tu-Cheng (TW); PETER KUO, Tu-Cheng (TW)

(73) Assignee: HON HAI PRECISION INDUSTRY CO., LTD., Tu-Cheng (TW)

(21) Appl. No.: 12/879,510

(22) Filed: Sep. 10, 2010

(30) Foreign Application Priority Data
Sep. 10, 2009 (TW) 98130461

(51) Int. Cl. H01R 13/58

(52) U.S. Cl. 439/449

(57) ABSTRACT

A cable assembly, used out of an electronic device, includes an electrical connector, a flexible printed circuit having a first end electrically connected to a rear end of the electrical connector, a flat tube covering the flexible printed circuit and having a front portion with a front end, a strain relief portion covering the front portion of the flat tube with the front end of the flat tube exposed out thereof, and a cover covering the rear end of the electrical connector, the first end of the flexible printed circuit, the front end of the flat tube and a front end of the strain relief portion.

### BACKGROUND OF THE INVENTION

1. Field of the Invention

The present invention relates generally to a cable assembly, and more particularly to a low profile cable assembly with a flat cable.

2. Description of the Prior Art

The communication between two electronic devices is always achieved through some external cable assembly. The external cable assembly is composed of a plurality of wires and an electric connector. However, too much wires would make the assembly complex. In present electronic device, flexible flat cable (FFC) or flexible printed circuit (FPC) have been inducted to be instead of original wires. However, present structure of cable assembly with FFC or FPC is not adapt for being used as an external cable assembly.

Hence, in this art, a cable assembly to overcome the above-mentioned disadvantages of the prior art should be provided.

### BRIEF SUMMARY OF THE INVENTION

A primary object, therefore, of the present invention is to provide a cable assembly with an improved coupling structure.

In order to implement the above object, a cable assembly, used out of an electronic device, comprises an electrical connector, a flexible printed circuit having a first end electrically connected to a rear end of the electrical connector, a flat tube covering the flexible printed circuit and having a front portion with a front end, a strain relief portion covering the front portion of the flat tube with the front end of the flat tube exposed out thereof, and a cover covering the rear end of the electrical connector, the first end of the flexible printed circuit, the front end of the flat tube and a front end of the strain relief portion.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a cable assembly in according with the present invention;

FIG. 2 is an exploded, perspective view of the cable assembly in according with the present invention;

FIG. 3 is a partly assembled perspective view of the cable assembly in according with the present invention.

### DETAILED DESCRIPTION OF THE INVENTION

Reference will now be made in detail to a preferred embodiment of the present invention.

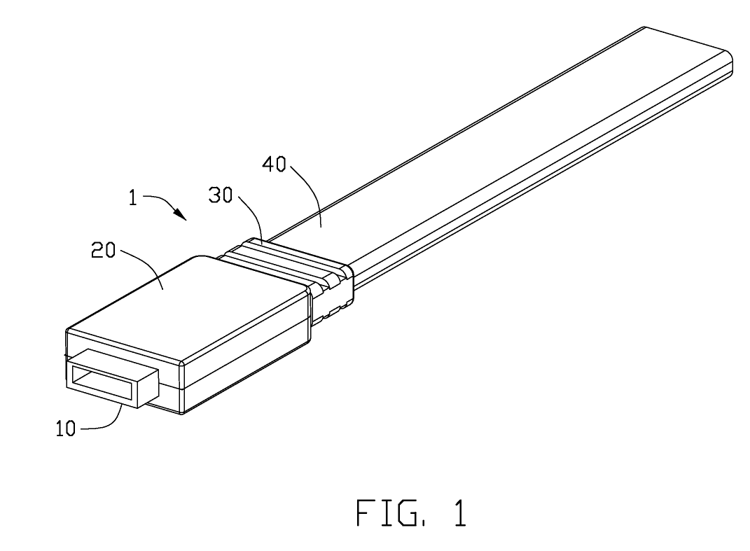

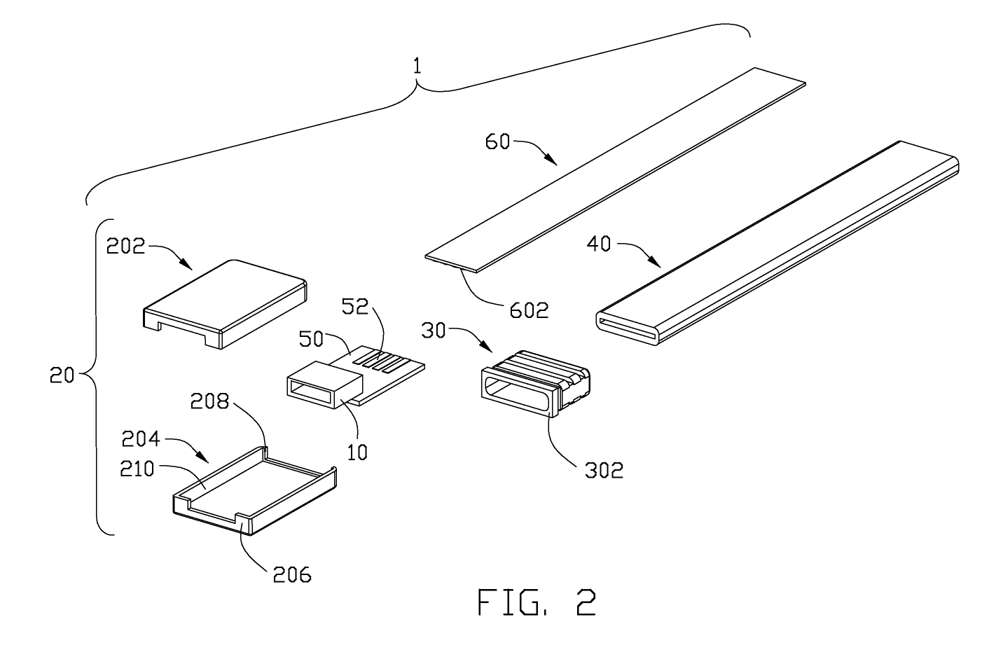

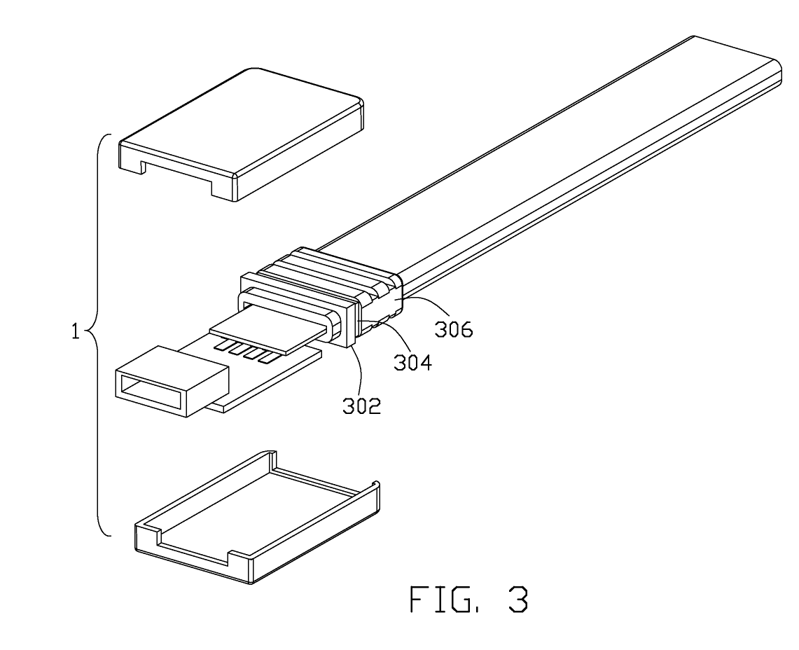

Reference to FIG. 1 to FIG. 3, A cable assembly, used out of an electronic device, comprises an electrical connector 10, a flat cable connected to the electrical connector 10, a strain relief portion 30, a cover 20, and a printed circuit board 50. The flat cable comprises a flexible printed circuit 60 having a first end electrically connected to a rear end of the electrical connector 10, and a flat tube 40 covering the flexible printed circuit 60 and having a front portion with a front end. The strain relief portion 30 covers the front portion of the flat tube 40 with the front end of the flat tube 40 exposed out thereof. The cover 20 covers the rear end of the electrical connector 10, the first end of the flexible printed circuit, the front end of the flat tube 40 and a front end of the strain relief portion 30.

The printed circuit board 50 is located between the electrical connector 10 and the flexible printed circuit 60 and has a plurality of pins 502 respectively arranged on the two opposite ends thereof. The printed circuit board 50 is respectively connected to the electrical connector 10 and the flexible printed circuit 60 on two opposite ends thereof.

The flat tube 40 and the strain relief portion 30 are made from flexible insulation material and molded as an integer. The strain relief portion 30 comprises a base portion 306, a fastening portion 302 in front of the base portion 302 and a groove 304 depressing from four surfaces of the base portion 306 and connected to the fastening portion 302. The fastening portion 302 is longer and wider than the base portion 306.

The cover 20 can be made from metal or insulation material. The cover 20 comprises an upper cover 202 and a lower cover 204. The upper cover 202 and the lower cover 204 are respectively assembled on the electrical connector 10 integrated with the printed circuit board 50, the flexible printed circuit 60, the flat tube 40 and the strain relief portion 30 from above and from below. The upper cover 202 and the lower cover 204 form a receiving space (not labeled) and a front wall 206, rear wall 208 and a pair of side walls 210 connecting the front wall 206 to the rear wall 208. The front wall 206, the rear wall 208 and the side walls 210 surround the receiving space. The printed circuit board 50, the rear end of the electrical connector 10, the front end of the flexible printed circuit 60, the front end of the strain relief portion 30 and the front end of the flat tube 40 are received in the receiving space. The fastening portion 302 is received in the receiving space and the rear wall of the cover 20 is inserted into the groove 304 of the strain relief portion 30. In other embodiment, the flexible printed circuit 60 can be replaced by flexible flat cable. And the printed circuit board 50 can be canceled, and the flexible printed circuit is physically connected to the electrical connector 10.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. A cable assembly, used as an external cable assembly, comprising:
an electrical connector;
a flexible printed circuit having a first end electrically connected to a rear end of the electrical connector;
a flat tube covering the flexible printed circuit and having a front portion with a front end;
a strain relief portion covering the front portion of the flat tube with the front end of the flat tube exposed out thereof; and
a cover covering the rear end of the electrical connector, the first end of the flexible printed circuit, the front end of the flat tube and a front end of the strain relief portion.

2. The cable assembly as claimed in claim 1, further comprising a printed circuit board located between the electrical connector and the flexible printed circuit and respectively connecting to the electrical connector and the flexible printed circuit on two opposite ends thereof.

3. The cable assembly as claimed in claim 2, wherein said flat tube and the strain relief portion are made from flexible insulation material.

4. The cable assembly as claimed in claim 3, wherein said flat tube and the strain relief portion are molded together.

5. The cable assembly as claimed in claim 4, wherein said strain relief portion comprises a base portion, a fastening portion in front of the base portion and a groove depressing from four surfaces of the base portion and connected to the fastening portion.

6. The cable assembly as claimed in claim 5, wherein said fastening portion is longer and wider than the base portion.

7. The cable assembly as claimed in claim 6, wherein said cover comprises an upper cover and a lower cover, the upper cover and the lower cover form a receiving space and the printed circuit board is received in the receiving space.

8. The cable assembly as claimed in claim 7, wherein said fastening portion is received in the receiving space of the cover and the cover has a rear wall inserted into the groove of the strain relief portion.

9. A cable assembly, used out of an electronic device, comprising:
an electrical connector;
a flexible flat cable having a first end electrically connected to a rear end of the electrical connector;
a flat tube covering the flexible flat cable and having a front portion with a front end;
a strain relief portion covering the front portion of the flat tube with the front end of the flat tube exposed out thereof; and
a cover covering the rear end of the electrical connector, the first end of the flexible flat cable, the front end of the flat tube and an front end of the strain relief portion.

10. The cable assembly as claimed in claim 9, further comprising a printed circuit board located between the electrical connector and the flexible flat cable and respectively connecting to the electrical connector and the flexible flat cable on two opposite ends thereof.

11. The cable assembly as claimed in claim 10, wherein said flat tube and the strain relief portion are made from flexible insulation material.

12. The cable assembly as claimed in claim 11, wherein said flat tube and the strain relief portion are molded as an integer.

13. The cable assembly as claimed in claim 12, wherein said strain relief portion comprises a base portion, a fastening portion in front of the base portion and a groove depressing from four surfaces of the base portion and connected to the fastening portion.

14. The cable assembly as claimed in claim 13, wherein said fastening portion is longer and wider than the base portion.

15. The cable assembly as claimed in claim 14, wherein said cover comprises an upper cover and a lower cover, the upper cover and the lower cover form a receiving space and the printed circuit board is received in the receiving space.

16. The cable assembly as claimed in claim 15, wherein said fastening portion is received in the receiving space of the cover and the cover has a rear wall inserted into the groove of the strain relief portion.

17. A cable connector assembly comprising:
a printed circuit board;
an electrical connector mechanically and electrically connected to a front portion of the printed circuit board;
a flexible flat cable electrically connected to a rear portion of the printed circuit board and including an insulative protective flat tube to enclose interior conductors;
a strain relief located around the rear portion of the printed circuit board and enclosing said flexible flat cable; and
a cover including two halves to enclose the printed circuit board and sandwich and expose the connector and the strain relief.

18. The cable connector assembly as claimed in claim 17, wherein said flexible flat cable includes a flexible printed circuit enclosed in said flat tube.
